(19) United States
(12) Patent Application Publication
(10) Pub. No.: US 2007/0047508 A1
(43) Pub. Date: Mar. 1, 2007

(54) Quality guarantee method for mobile terminal communication

(75) Inventors: Hitoshi Yamada, Kawasaki (JP); Akiko Yamada, Kawasaki (JP); Keiichi Nakatsugawa, Kawasaki (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/282,639

(22) Filed: Nov. 21, 2005

(30) Foreign Application Priority Data
Aug. 31, 2005 (JP) 2005-251121

(51) Int. Cl. H04Q 7/24

(52) U.S. Cl. 370/338; 370/310

(57) ABSTRACT

To achieve end-to-end quality guarantee in regard to communication with a mobile terminal (node) in a carrier network in which Mobile IP is presupposed, in an IP network, quality guarantee is realized by performing network resource reservation in a resource reservation server receiving a resource reservation request from a node. The resource reservation server receives the resource reservation request, and decides whether the node initiating the resource reservation request is a mobile node. When the above resource reservation request is initiated from the mobile node, resource reservation is performed for the route between the mobile node and the correspondent node via a mobility management server having a home address of the mobile node.

### CROSS-REFERENCE TO RELATED APPLICATIONS

This application is based upon and claims the benefit of priority from the prior Japanese Patent Application No. 2005-251121, filed on Aug. 31, 2005, the entire contents of which are incorporated herein by reference.

### BACKGROUND OF THE INVENTION

1. Field of the Invention

The present invention relates to an end-to-end quality guarantee method in regard to communication with a mobile communication terminal (node) in a carrier network on the presupposition of using Mobile IP.

2. Description of the Related Art

When communication between terminals (nodes) is performed in a network, network resource reservation is required in order to guarantee QoS (Quality of Service) with respect to bandwidth, delay, etc. As the prior art for dynamically reserving network resources in an IP network, there have been applied a distribution control method by use of RSVP (Resource Reservation Protocol), and a centralized control by a resource reservation server such as so-called a bandwidth broker (BB).

An example of a quality guarantee method, using RSVP, a prior art is explained hereafter, referring to FIG. 1. A plurality of routers Rl-Rn are installed in an IP network 100.

Now, an RSVP message is transmitted from a terminal N1 initiating a request (hereafter referred to as requesting node N1) addressed to a terminal N2 of the communication party to which the request is destined (hereafter referred to as requested correspondent node N2), so as to request registration (S1) . The RSVP message includes a QoS parameter such as a bandwidth value requested for reservation.

The RSVP message is transferred from router to router using an ordinary IP routing scheme. When each router R1, R7, R8 and R4 located on the above transfer route receives the RSVP message, resources are reserved according to the parameters (S2).

The example shown in FIG. 1 illustrates a state that resources are reserved on a route section 101 passing through the routers R1, R7, R8 and R4.

In the actual RSVP, after a message (PATH) is once transferred from the requesting node N1 to the requested correspondent node N2, a response message (RESERVE) is returned from the requested correspondent node N2 to the requesting mobile node N1. At this time, the resource reservation is completed (S2).

However, in the method using RSVP, it is necessary for each router to retain a state for each IP flow. Therefore, generally, it is hardly possible to cope with a multiplicity of flows. Due to the above lack of scalability, the method is not applicable to a carrier network.

In addition, according to the distribution control method using RSVP, there is a lack of control flexibility because of difficulty in controlling traffic routes. Therefore, recently, attention is paid on the centralized control method.

According to the resource reservation method by the centralized control, a node informs a resource reservation server of quality parameters including the self-node address, a correspondent node address and a bandwidth, as reservation message. Based on the information, the resource reservation server reserves necessary resources.

FIG. 2 shows an exemplary method of the conventional centralized control, namely, a quality guarantee method using a resource reservation server SV1. A requesting node N1, requesting resource reservation to guarantee communication quality, transmits a resource reservation request message to the resource reservation server SVl (step S1). As shown in FIG. 3., the above resource reservation request message has QoS parameters including: (a) session information for identifying the session for guarantee; (b) IP address of the requesting node N1; (c) IP address of the requested correspondent node N2; (d) desired bandwidth to be reserved; and (e) upper limit value of tolerable transfer delay.

For the above resource reservation request message, protocols such as DIAMETER and HTTP (Hypertext Transfer Protocol) may be used. Also, a protocol called NSIS (Next Step in Signaling), which is discussed recently in the IETF (Internet Engineering Task Force), may be used. The resource reservation server SV1 examines the resources on the route between the requesting node N1 and the requested correspondent node N2. At this time, if there are sufficient resources for satisfying the request, the request is accepted and the resources on the route are reserved (step S12).

Practically, the resource reservation is performed by setting bandwidth control and priority control from the resource reservation server SV1 to the routers, using CLI (Command Line Interface),COPS (Common Open Policy Service) protocol, SNMP (Simple Network Management Protocol), etc. The above setting signifies, for example, setting to the routers a queue priority and a readout bandwidth in the Diffserv architecture, and setting a bandwidth guaranteed path in the MPLS (Multi-protocol Label Switching) architecture.

However, in the method using the conventional resource reservation server, there is the problem that in the network operated with Mobile IP, resource reservation is not possible end-to-end.

Here, Mobile IP is a protocol enabling mobility in the IP network, so that communication can be continued even when a mobile node MN moves and the address is changed. In Mobile IP, a fixed home address HoA and a care-of address CoA being temporarily used at a visiting location are allocated on a node-by-node basis.

A mobility management server (or home agent) HA manages the relationship of correspondence between the home address HoA and the care-of address CoA of each node. As to traffic between the mobile node MN and the correspondent node CN, the correspondent node CN can communicate with the mobile node MN by transferring the traffic via the mobility management server HA, without being conscious of the movement of the mobile node MN.

Namely, in an IP packet from the mobile node MN destined to the correspondent node CN, the home address HoA of the mobile node MN is specified as source address, and the address of the correspondent node CN is specified as destination address. Then, the above IP packet is encapsulated with the care-of address CoA of the mobile node MN being specified as source address, and the mobility management server HA being specified as destination address. The encapsulated IP packet is then transferred to the mobility management server HA.

On receipt of the packet, the mobility management server HA decapsulates the packet. The packet is then transferred to the correspondent node CN in the form of a packet having the home address HoA of the mobile node MN as source address, and the correspondent node CN as destination address. Reversely, an IP packet to be transmitted from the correspondent node CN to the mobile node MN has the correspondent node CN as source address, and the home address HoA of the mobile node MN as destination address. The packet is transferred to the mobility management server HA, and received therein.

The mobility management server HA encapsulates the received packet having the mobility management server HA as source address and the care-of address CoA of the mobile node MN as destination address. The encapsulated packet is transferred to the mobile node MN.

Further, in a different form, a packet to be transmitted from the mobile node MN and destined to the correspondent node CN is transmitted directly to the correspondent node CN without being transmitted through the mobility management server HA. At this time, the IP packet to be transmitted from the mobile node MN destined to the correspondent node CN has the home address HoA of the mobile node MN as source address. With this, a packet from the correspondent node CN destined to the mobile node MN is transmitted through the mobility management server HA. Accordingly, the traffic between the mobile node MN and the correspondent node CN flows on a triangle route. Hereafter, the case of traffic transmitted in the above form is referred to as traffic by triangle route.

Further, in Mobile IP, an optional function of route optimization is also defined. When the route optimization is applied, the mobile node MN informs not only the mobility management server HA but also the correspondent node CN about the care-of address CoA. By this, the mobile node MN and the correspondent node CN can directly communicate, in both directions, without being transmitted via the mobility management server HA. However, to perform the above, the correspondent node CN has to incorporate Mobile IP, as well as the route optimization function. Generally, the above route optimization function will not be installed in an ordinary terminal, i.e. not a mobile node.

Now, in the network in which Mobile IP is operated, it is considered to guarantee communication quality between the mobile node MN and the correspondent node CN by initiating a request from the mobile node MN to the resource reservation server.

As a request message for guaranteeing quality, the mobile node MN transmits the IP address of the requesting mobile node MN, the IP address of the requested correspondent node CN, and a bandwidth value desired for reservation. Here, as the IP address of the requesting mobile node MN, either the home address or the care-of address of the mobile node MN is used. An operation example in the case of using the home address of the mobile node MN is shown in FIG. 4, with an example of a reservation message as shown in FIG. 5. Also, an operation example in the case of using the care-of address is shown in FIG. 6, with an example of a corresponding reservation message as shown in FIG. 7.

FIG. 4 shows that a requesting mobile node MN1 has a home address HoA1 and a care-of address CoA1, when the mobile node MN1 moves from a home network HN to an external network EXN.

At this time, as shown in FIG. 5, when the home address HoA1 [(b)] is used as the address of the requesting mobile node MN1 in the reservation message, the home address HoA1 represents the address HoA in the home network HN. Accordingly, on receiving the above reservation message, the resource reservation server SV1 reserves resources between the router R5, being connected to the home network HN in which a mobility management server HA1 is located, and the router R4, being connected to a network in which the correspondent node CN1 is located (step S22). However, actual traffic between the mobile node MN1 and the correspondent node CN1 flows through a route of MN1-(R1-R5)-HA1-(R5-R4)-CN1, as shown by the bold line with arrow in FIG. 4. Therefore, since the resource reservation on (R1-R5) is not performed, it is not possible to guarantee the quality for the route concerned.

Similarly, FIG. 6 shows an example when the care-of address CoA1 of the mobile node MN1 is used as a requesting address in the reservation message. At this time, the care-of address CoA1 represents an address in the external network EXN. Therefore, on receiving the reservation message (S31) from the mobile node MN1, the resource reservation server SV1 reserves resources 101 between the router R1, being connected to the external network EXN in which the mobile node MN1 is located, and the router R4, being connected to the network in which the requested correspondent node CN1 is located (S32).

However, when the route optimization is not performed, actual traffic between MN1 and CN1 flows through a route of MN1-(R1-R5)-HA1-(R5-R4)-CN1, as shown by the bold line with arrow. Therefore, since the resource reservation on this route is not performed, it is not possible to guarantee the quality for the route concerned.

According to the prior art having been described above, when the mobile node MN1 performs communication via the mobility management server HA1 in a Mobile IP network, there has been a problem such that the quality cannot be guaranteed by performing end-to-end resource reservation using the resource reservation server SV1.

Now, as a technique having been disclosed in the official gazette of the Japanese Unexamined Patent Publication No. 2001-308932 (which is referred to as Patent document 1), it is shown a method for enabling modification of service control information, by transmitting service content modification information from a mobile node to resource management equipment. Also, in the official gazette of the Japanese Unexamined Patent Publication Nos. 2000-253069 and 2003-60684 (which are referred to as Patent documents 2 and 3, respectively), there are descriptions in regard to the resource reservation method by use of RSVP.

According to the technique disclosed in the patent document 1, bandwidth control, etc. are considered as service. However, the disclosed method is not a resource reservation method throughout the overall routes by grasping the end-to-end routes.

Also, the techniques disclosed in the patent documents 2, 3 relate to RSVP. As described earlier, such techniques are not applicable to a large-scale network. Furthermore, according to the RSVP method, there also remains the problem that it is not possible to perform optimal control of a traffic route through the network, because of accepting resource reservation requests as many as possible.

### SUMMARY OF THE INVENTION

Accordingly, in order to solve the aforementioned problem, it is an object of the present invention to provide a means for guaranteeing quality end to end in regard to communication with a mobile terminal in a carrier network based on the presupposition of Mobile IP, which is a centralized quality guarantee method different from the prior arts disclosed in the above-mentioned patent documents 2, 3.

According to the present invention in order to solve the aforementioned problem, a resource reservation server has a function of deciding whether a request is initiated from a mobile node. Namely, the resource reservation server is informed about not only a home address but also a care-of address as a requesting node address in a request message originated from a mobile node. On receiving the above information, the resource reservation server recognizes that the request is initiated from the mobile node. Thus, it is possible for the resource reservation server to perform resource reservation on the route between the mobile node and a correspondent node passing through a mobility management server.

Alternatively, it may be possible to inform about only the home address as the requesting node address in the request message originated from the mobile node. On receiving the above information, the resource reservation server decides whether the request is originated from the mobile node by inquiring of the mobility management server corresponding to the home address when the mobility management server is existent. The resource reservation server inquires of the mobility management server whether the requesting node has moved to a different network, and inquires about the care-of address indicating the visiting location in case the requesting node has moved. With this, the resource reservation server comes to know the visiting location of the mobile node. Thus, it is possible for the resource reservation server to perform resource reservation on the route between the mobile node and the correspondent node passing through the mobility management server.

Further, when communication between the nodes is performed on a triangle route, the requesting node informs of the triangle route at the time of the resource reservation request. Thus, it is also possible for the resource reservation server to perform resource reservation as to the traffic destined to the correspondent node CN, which is transmitted on the route not passing through the mobility management server.

Further, when route optimization is performed between the nodes, by informing to that effect from the requesting mobile node at the time of the resource reservation request, it may also be possible for the resource reservation server to perform resource reservation on the route between the nodes, not passing through the mobility management server.

Still further, in order to improve the effect of end-to-end quality guarantee, the following means are employed:

In case route optimization is not performed in Mobile IP, an ordinary IP packet between the mobile node and the mobility management server is encapsulated. This causes the packet size larger, which requires a larger bandwidth. Taking the above into account, an extra bandwidth is reserved so as to secure a larger bandwidth than requested. Thus, an effect of the quality guarantee can be increased.

Further, when the mobility management server performs transfer processing for a multiplicity of mobile nodes in case route optimization is not performed, the processing load becomes increased, which possibly causes a reduction of the transfer speed. To avoid the above situation, the resource reservation server decides whether resource reservation can be performed, taking into account the transfer processing capacity of the mobility management server. Thus, an effect of the quality guarantee can be increased.

According to the present invention, from a reservation message originated from a node, a resource reservation server decides whether the reservation is requested from a mobile node. When the request is originated from the mobile node, the resource reservation server performs resource reservation for corresponding appropriate sections. Thus, it becomes possible to provide end-to-end quality guarantee. For example, the mobile node informs the resource reservation server about a home address and a care-of address as self-mobile node addresses, and a correspondent node address as well. This enables the resource reservation server to perform resource reservation for the entire sections, also in regard to the communication via a home network of the mobile node.

With this, it becomes possible to provide a quality guarantee means in regard to communication with a mobile node in a carrier network in which Mobile IP is presupposed.

Further scopes and features of the present invention will become more apparent by the following description of the embodiments with the accompanied drawings.

### BRIEF DESCRIPTION OF THE DRAWINGS

FIG. 1 shows a diagram illustrating a quality guarantee method by means of RSVP, according to the prior art.

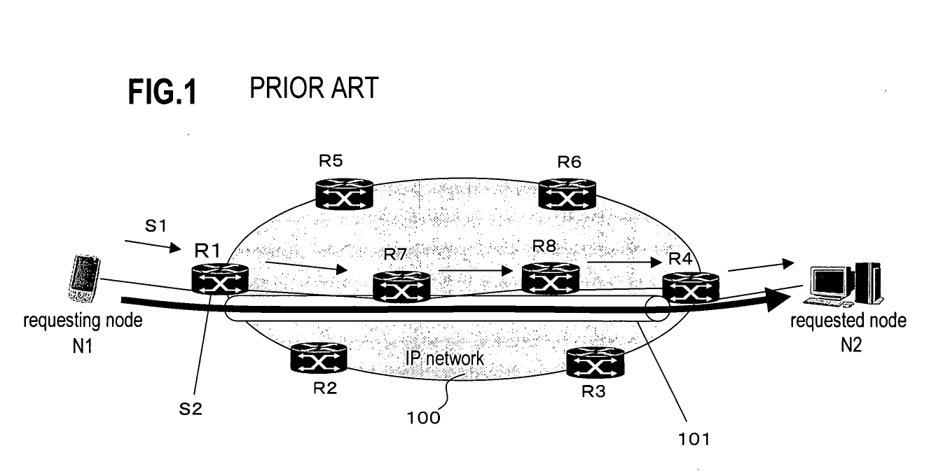

FIG. 2 shows a diagram illustrating a quality guarantee method by means of a resource reservation server, according to the prior art.

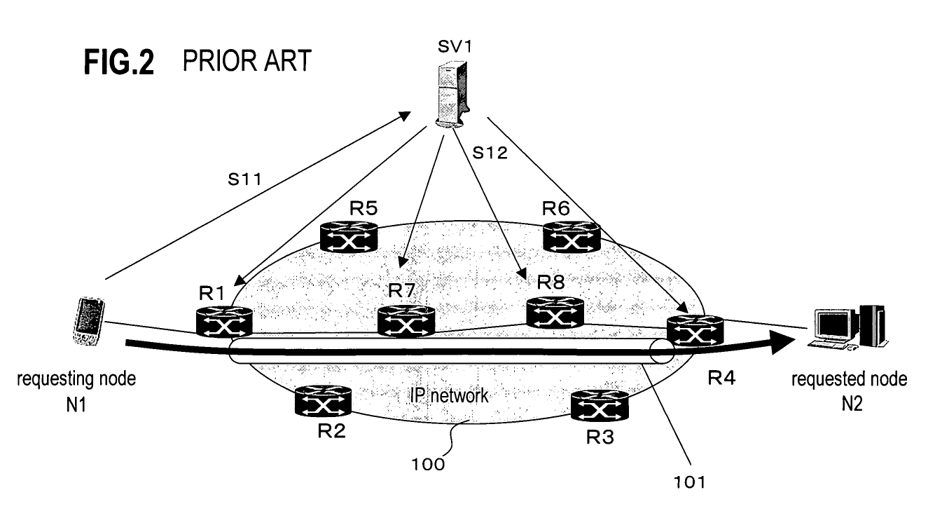

FIG. 3 shows a diagram illustrating an example of a request message to a resource reservation server, according to the prior art.

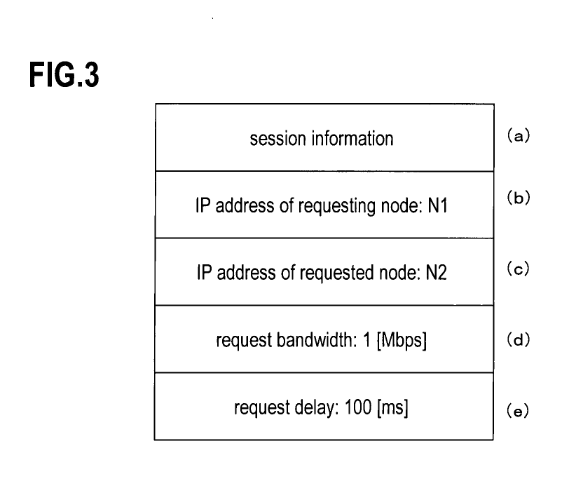

FIG. 4 shows a diagram illustrating a state when quality guarantee of a mobile IP node is to be performed by a resource reservation server according to the prior art, using the request message shown in FIG. 5.

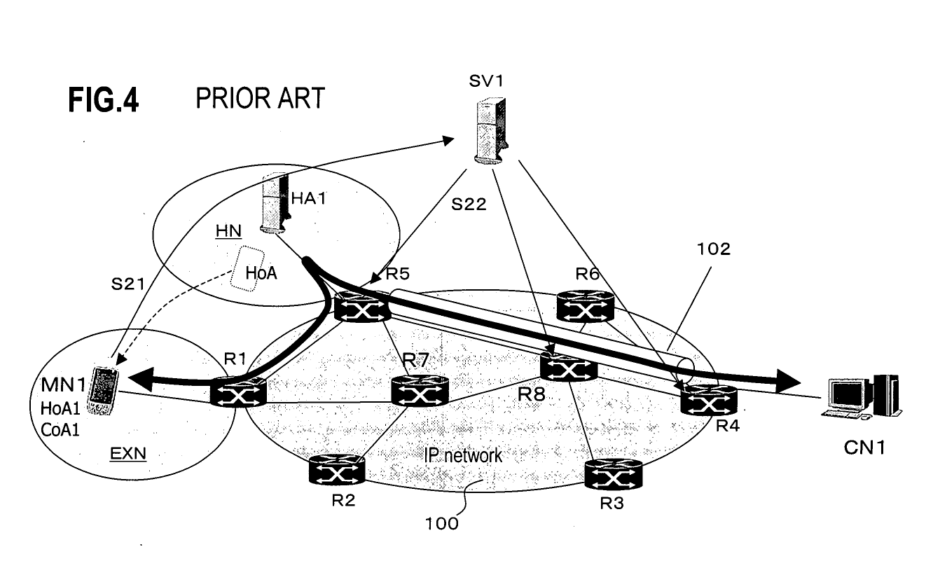

FIG. 5 shows a diagram illustrating an example of a request message to a resource reservation server, according to the prior art.

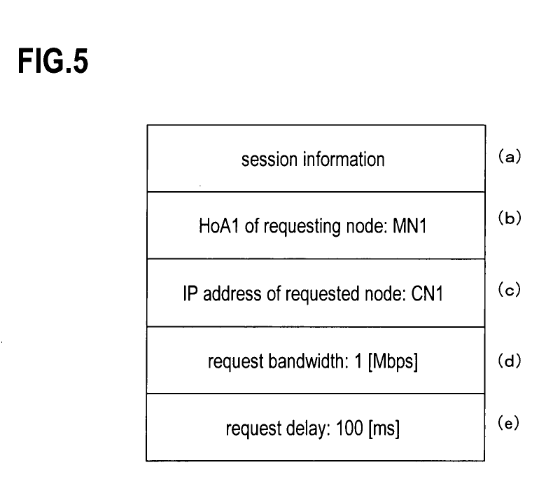

FIG. 6 shows a diagram illustrating a state when quality guarantee of a mobile IP node is to be performed by a resource reservation server according to the prior art, using the request message shown in FIG. 7.

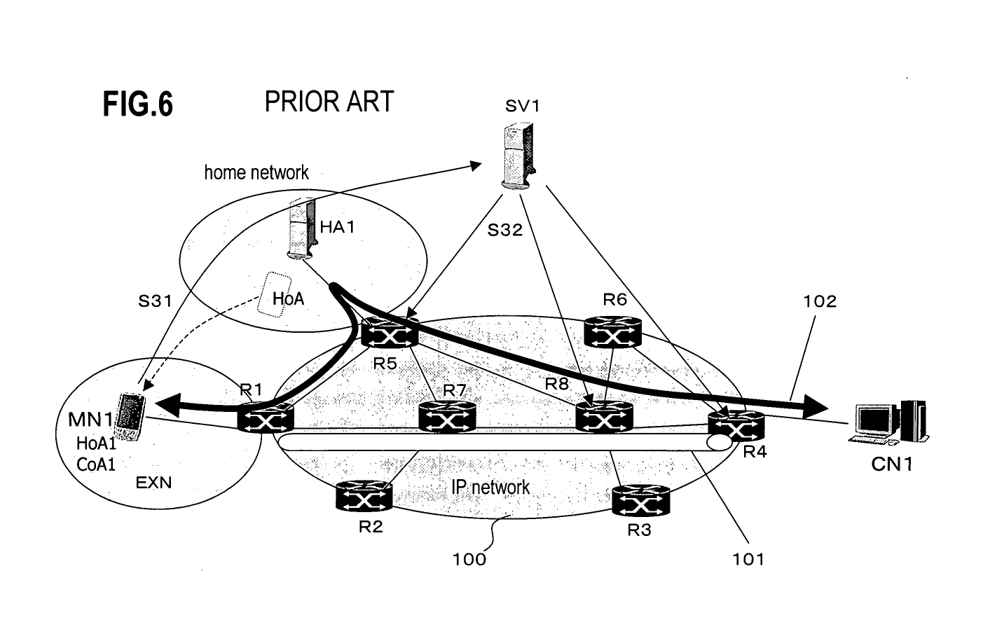

FIG. 7 shows a diagram illustrating an example of a request message to a resource reservation server, according to the prior art.

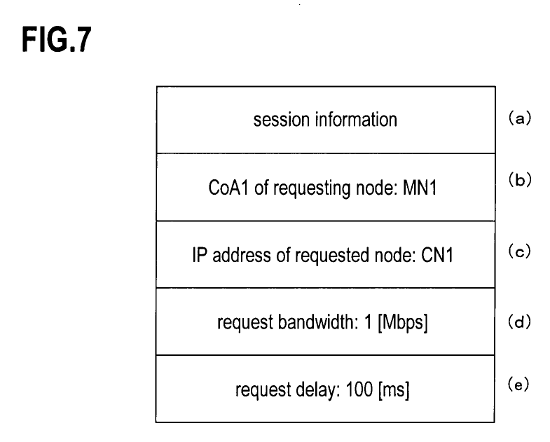

FIG. 8 shows a diagram illustrating an embodiment 1 of a quality guarantee method according to the present invention, by means of a resource reservation server.

FIG. 9 shows a diagram illustrating an example of a request message, according to an embodiment 1 of the present invention.

FIG. 10 shows a functional block diagram of a mobile node according to the present invention.

FIG. 11 shows a diagram illustrating a resource reservation sequence, according to an embodiment 1 of the present invention.

FIG. 12 shows a diagram illustrating an example of a functional block diagram of a resource reservation server according to the present invention.

FIG. 13 shows a diagram illustrating an example of a processing flow in a resource reservation server according to the present invention.

FIG. 14 shows a diagram illustrating an embodiment 2 of a quality guarantee method by means of a resource reservation server according to the present invention.

FIG. 15 shows a diagram illustrating an example of a request message, according to an embodiment 2 of the present invention.

FIG. 16 shows a diagram illustrating an embodiment 3 of a quality guarantee method by means of a resource reservation server according to the present invention.

FIG. 17 shows a diagram illustrating an example of a request message, according to an embodiment 3 of the present invention.

FIG. 18 shows a diagram illustrating an embodiment 4 of a quality guarantee method by means of a resource reservation server according to the present invention.

FIG. 19 shows a diagram illustrating an example of a request message, according to an embodiment 4 of the present invention.

FIG. 20 shows a diagram illustrating a resource reservation sequence, according to an embodiment 4 of the present invention.

FIG. 21 shows a diagram illustrating an example of a functional block diagram of a resource reservation server according to the present invention.

FIG. 22 shows a diagram illustrating an example of a processing flow in a resource reservation server according to the present invention.

FIG. 23 shows a diagram illustrating an example of a functional block diagram of a mobility management server according to the present invention.

### DETAILED DESCRIPTION OF THE INVENTION

The preferred embodiment of the present invention is described here in after referring to the charts and drawings. However, it is to be noted that the scope of the present invention is not limited to the embodiments described below.

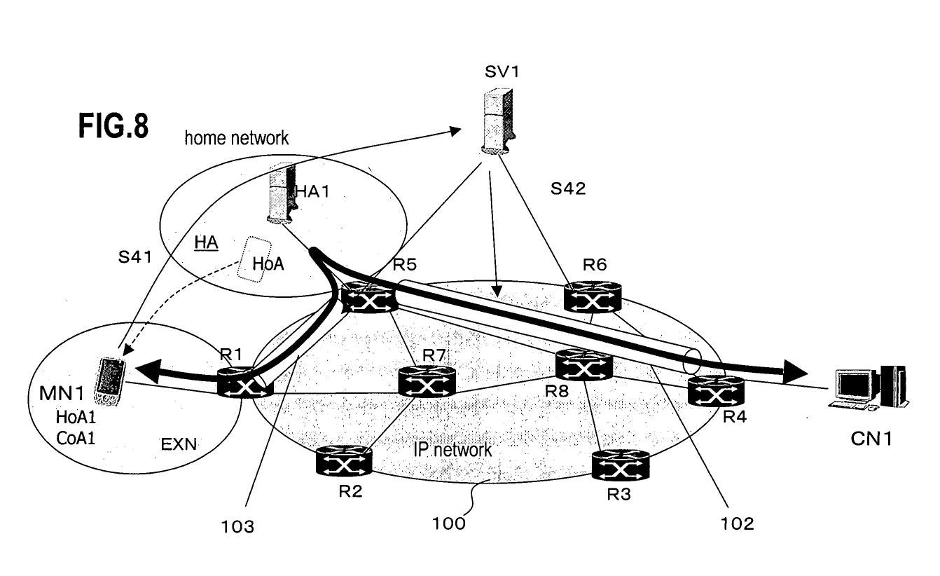

FIG. 8 shows a diagram illustrating an embodiment 1 of an end-to-end quality guarantee method according to the present invention, by means of a resource reservation server, in regard to communication with a mobile node in a carrier network in which Mobile IP is presupposed.

In FIG. 8, it is illustrated that a mobile node MN1 has a home address HoA and a care-of address CoA, when the mobile node MN1 moves from a home network HN to an external network EXN.

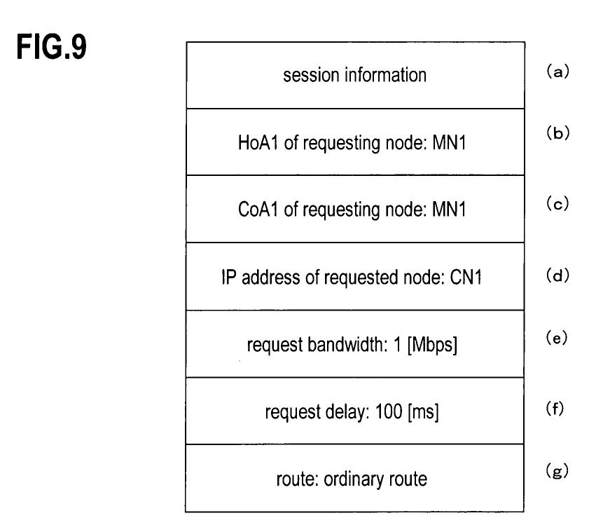

When the mobile node MN1 requests a resource reservation server SV1 for quality guarantee (S41), the mobile node MN1 transmits a request message as shown in FIG. 9 to a resource reservation server SV1. In the request message, the following are specified: (a) session information for identifying the session to be guaranteed; (b) home address HoAl and (c) care-of address CoAl of the requesting node MN1, as addresses originating the request; (d) IP address of a requested correspondent node CN1; (e) requested bandwidth; (f) requested delay (an upper limit value of a tolerable transfer delay) ; and, as a route, (g) ordinary route indicating that the communication between the mobile node MN1 and the correspondent node CN1 is performed through a mobility management server HA1.

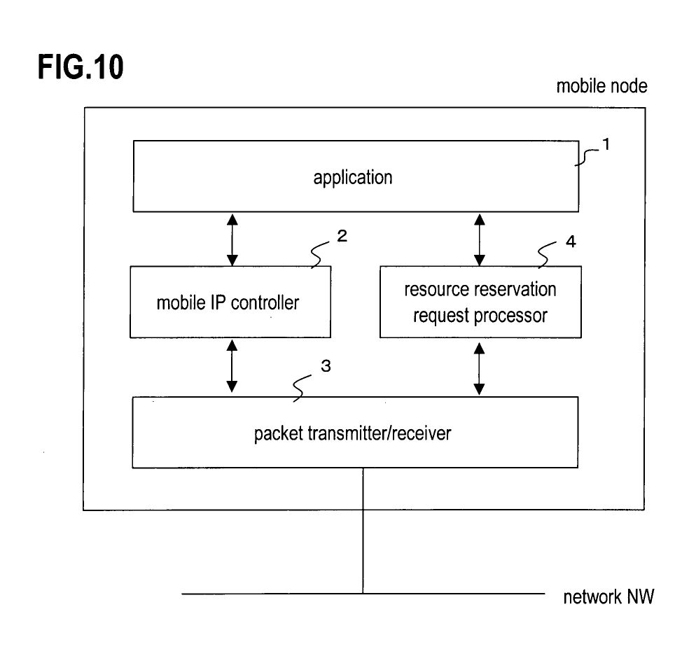

FIG. 10 shows an exemplary configuration of a functional block diagram of a mobile node MN1. By means of a communication function executed by an application program 1, data transmission/reception to/from a network is performed from a packet transmitter/receiver 3 via a mobile IP controller 2.

When application program 1 requests for quality guarantee, a resource reservation request processor 4 controls to transmit a reservation message as shown in the above FIG. 9 to the resource reservation server SV1.

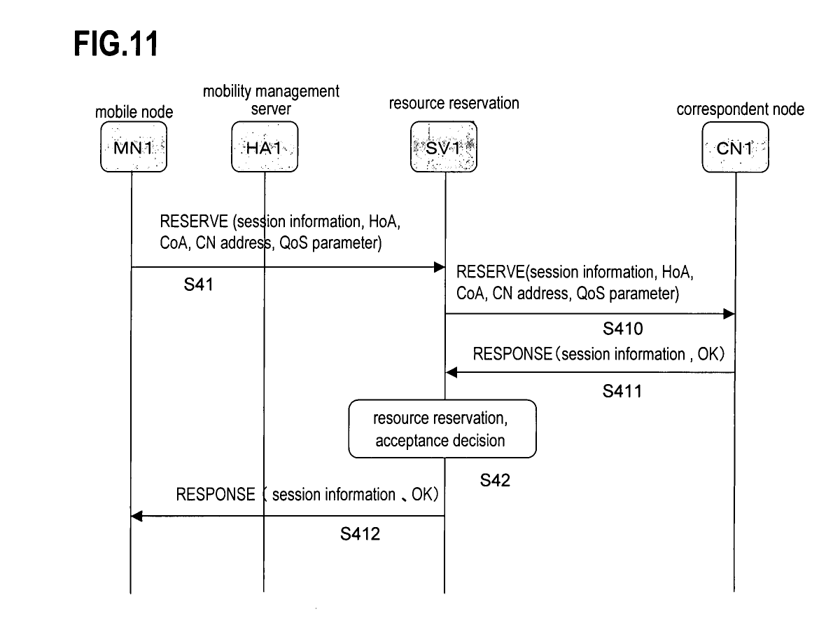

FIG. 11 shows a resource reservation sequence after the mobile node MN1 transmits the resource reservation request to the resource reservation server SV1.

In FIG. 11, the mobile node MN1 transmits a resource reservation request (RESERVE) toward the resource reservation server SV1 (step S41). This resource reservation request message is represented by a request message shown in FIG. 9. On receipt of the resource reservation request message, the resource reservation server SV1 transfers a reservation message (RESERVE) to the correspondent node CN1, so as to notify that quality guarantee is requested (step S410).

When the correspondent node CN1 can also perform quality guarantee communication, the correspondent node CN1 returns OK (accepted) to the resource reservation server SV1 by a response message (RESPONSE) (step S411). However, the above confirmation to the correspondent node CN1 is not mandatory. Thereafter, the resource reservation server SV1 performs resource reservation and acceptance decision (step S42). If the resource reservation is successful, the resource reservation server SV1 transmits a response message indicating OK (successful) to the requesting node (step S412).

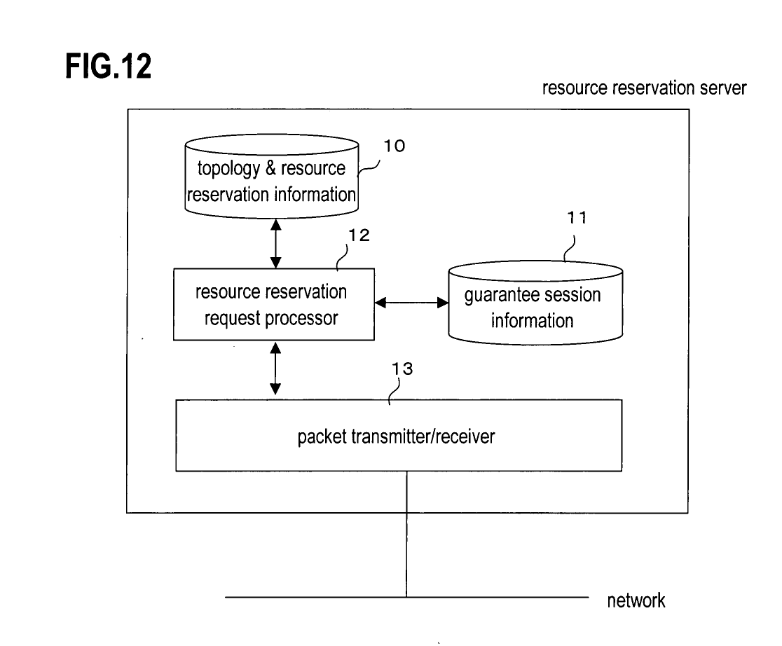

FIG. 12 shows an exemplary configuration a functional block diagram of a resource reservation server SV1, according to the first embodiment of the present invention. As information, the resource reservation server SV1 has topology & resource management information 10 and guarantee session information 11. Also, a resource reservation request processor 12 receives the resource reservation request from the mobile node, and performs processing corresponding to the above resource reservation request. Further, resource reservation request processor 12 performs packet data transmission and reception through a packet transmitter/receiver 13.

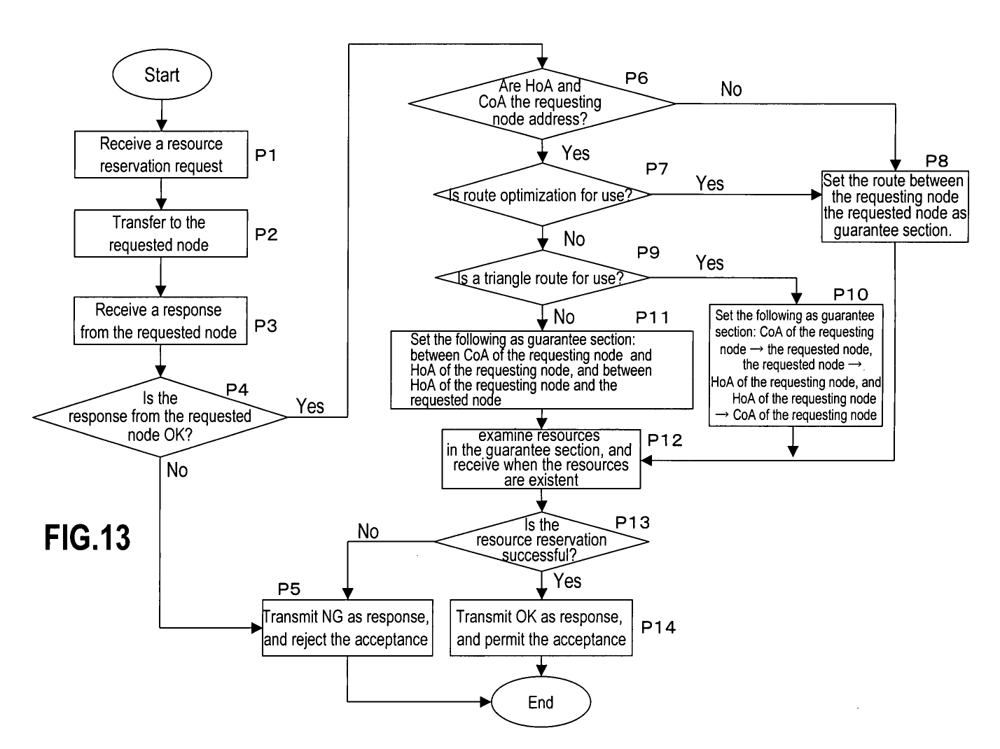

FIG. 13 shows a program flow in the resource reservation request processor 12.

In FIG. 13, when a resource reservation request (S41) is received from the mobile node MN1 (process P1), the resource reservation request is transferred to the requested correspondent node CN1 (process P2; S410). A response (S411) from the requested node is received (process P3). Then, it is decided whether or not the response from the requested node is OK (accepted) (process P4).

If the response from the requested node is NG (not accepted) (No in process P4), rejection of acceptance is returned to the mobile node MN1 as a response (process P5).

Meanwhile, if the response from the requested node is OK (Yes in process P4), it is decided whether or not a home address HoA and a care-of address CoA are included in the requesting node addresses of the request message (FIG. 9) (process P6).

When both the home address HoA and the care-of address CoA are included, it is decided whether the correspondent node CN1 uses an optimized route, namely, whether the correspondent node CN1 has an option for route optimization (process P7).

When the route optimization is used, it is signified that the direct route is used in both forward and backward directions of the transmission lines. Therefore, in the process P6, when it is decided that the home address HoA1 and the care-of address CoA1 are not included (No in process P6), and further it is decided that the route optimization is used (Yes in process P7), the route directly connecting the requesting mobile node MN1 to the requested correspondent node CN1, in other words, the route not passing through the mobility management server HA1, is set as a guarantee section (process P8). The detail of the process P8 will be described later.

Next, in case of deciding the route optimization is not used (No in process P7), it is decided whether or not a triangle route is used (process P9). Here, triangle route is a case of the route in which, as to transmission, a direct connection route between the requesting mobile node MN1 and the requested correspondent node CN1 is used, as in the case of using the route optimization, while as to reception, a route passing through the mobility management server HA1 is used.

When the above triangle route is used (Yes in process P9), the following sections are set as guarantee sections: the section from the care-of address CoA of the requesting node to the requested node; the section from the requested node to the home address HoA of the requesting node; and the section from the home address HoA of the requesting node to the care-of address CoA of the requesting node (process P10).

On the other hand, when the triangle route is not used (No in process P9), the following sections are set as guarantee sections: the section between the care-of address CoA and the home address HoA of the requesting node; and the section between the home address HoA of the requesting node and the requested node (process P11).

Next, the resources in the guarantee sections set in the above process P10 or P11 are examined, and if there are requested resources, the resources are reserved (process P12).

If the resource reservation is successful (Yes in process P13), an OK response is returned so as to permit the acceptance (process P14). If the resource reservation is not successful (No in process P13), an NG response is returned so as to reject the acceptance (process P5).

Here, when the resource reservation server SV1 reserves the requested bandwidth, if there are sections in which encapsulation by Mobile IP is performed in IP network 100, it may also be possible to reserve an extra bandwidth considering for the encapsulation.

For example, in FIG. 8, encapsulation is performed in a section 103 between the mobile node MN1 and the mobility management server HA1. Accordingly, assuming that an average packet size in the above section is 500 bytes, and an IP header size added by encapsulation is 20 bytes, it becomes possible to guarantee for the increment of the overhead further, if the reservation in the section concerned is performed 1.04 [=(500+20)/500] times as many as the requested bandwidth.

Moreover, if the transfer processing capacity of the mobility management server HA1 is also managed as a resource, it may be possible to decide whether resource reservation is acceptable, taking the above transfer processing capacity into account.

For example, assuming that the bandwidth requested from the mobile node MN1 is 1Mbps, if the remaining transfer processing capacity in the mobility management server HA1 is only 500 kbps, the request for resource reservation is rejected to accept. By this, it becomes possible to avoid quality deterioration in originally guaranteed communication caused by a decreased transfer speed in the mobility management server HA1. Thus, an effect of the quality guarantee can be enhanced.

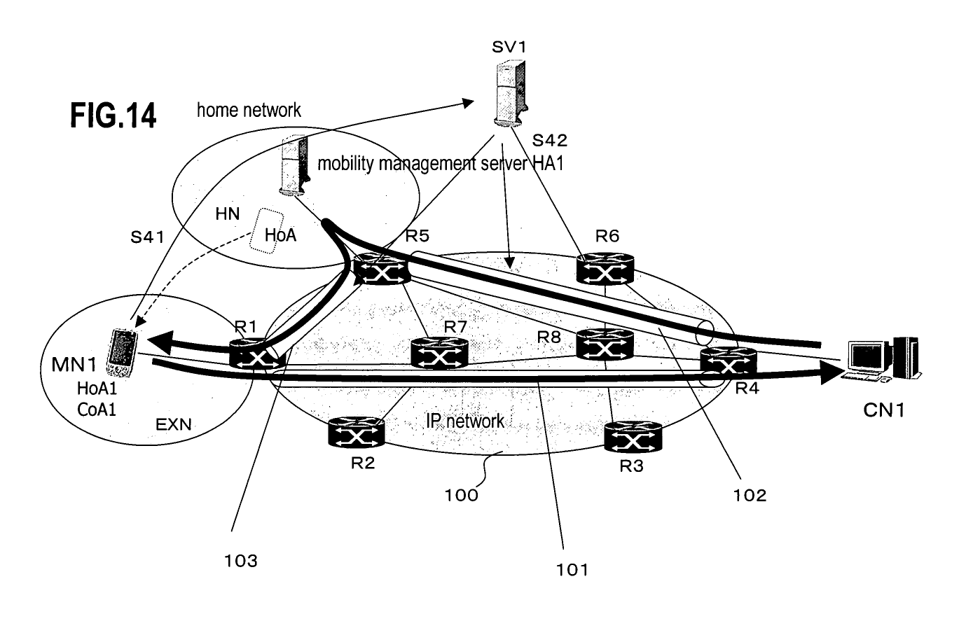

FIG. 14 shows an exemplary embodiment of setting a guarantee section (process P10), when a triangle route is used (Yes in process P9) in FIG. 13.

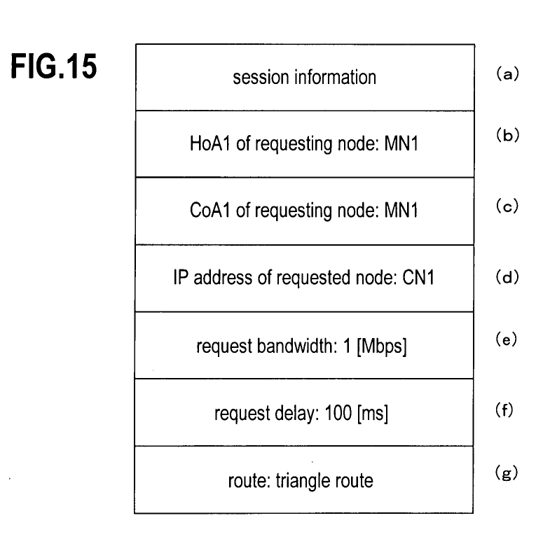

When communicating using the triangle route, the triangle route is specified in the route information of a request message originated from the mobile node MN1, as shown by (g) in FIG. 15. The resource reservation server SV1 reserves resources according to the route through which traffic flows between the mobile node MN1 and the correspondent node CN1, as shown in FIG. 14. More specifically, as guarantee sections, a forward route 101 from the care-of address CoA1 to the requested correspondent node CN1, a backward route 102 from the requested correspondent node CN1 to the home address HoA of the requesting node, and a backward route from the home address HoA of the requesting node to the care-of address CoA of the requesting node are set. Then, the resources on the above sections are reserved.

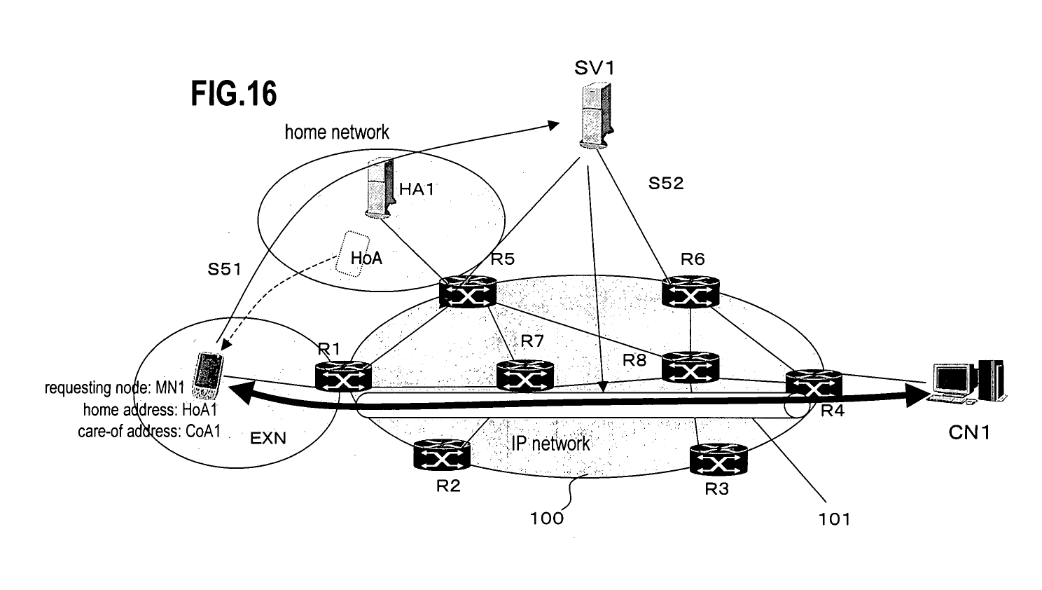

FIG. 16 shows a diagram illustrating an example when communication is performed using the route optimization in the flow shown in FIG. 13 (Yes in process P7).

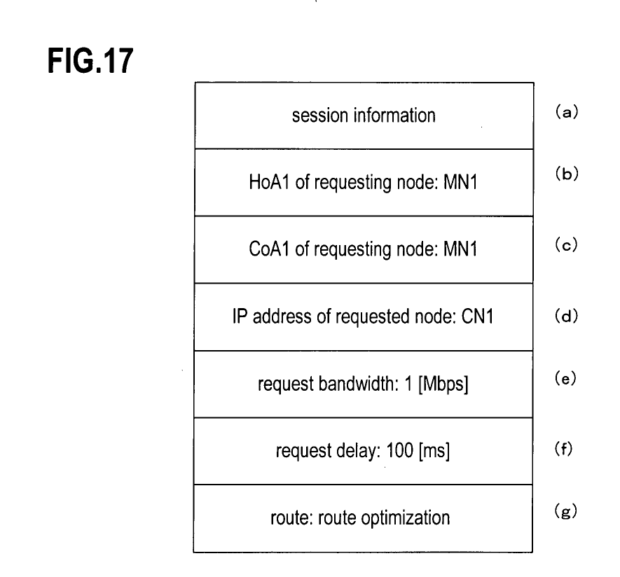

When communication is performed by means of route optimization, the route optimization is specified in the route information of a request message from the mobile node MN1, as shown by (g) in FIG. 17. By this, the resource reservation server SV1 reserves resources according to direct route 101 through which traffic passes between the mobile node MN1 and the correspondent node CN1, as shown in FIG. 16.

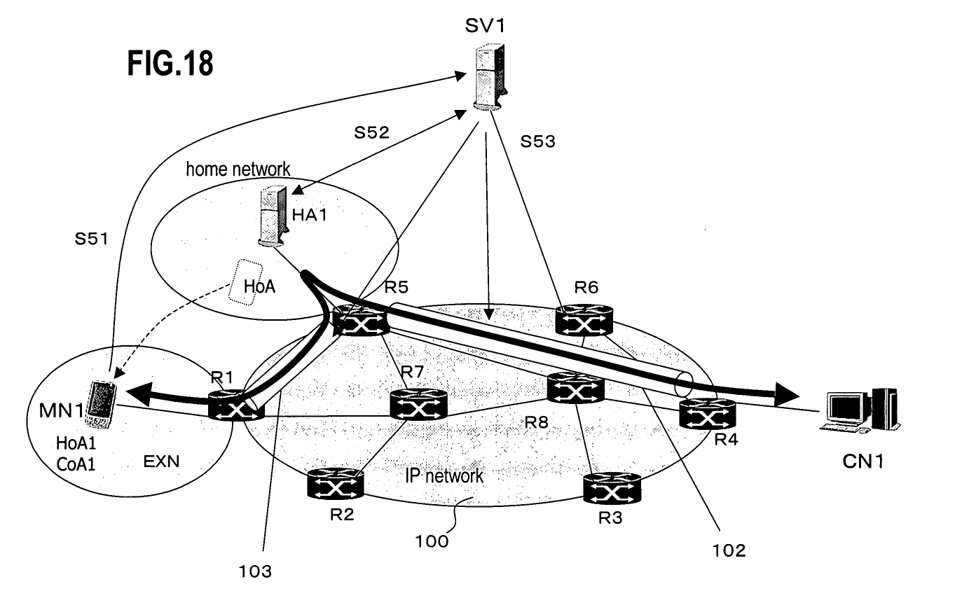

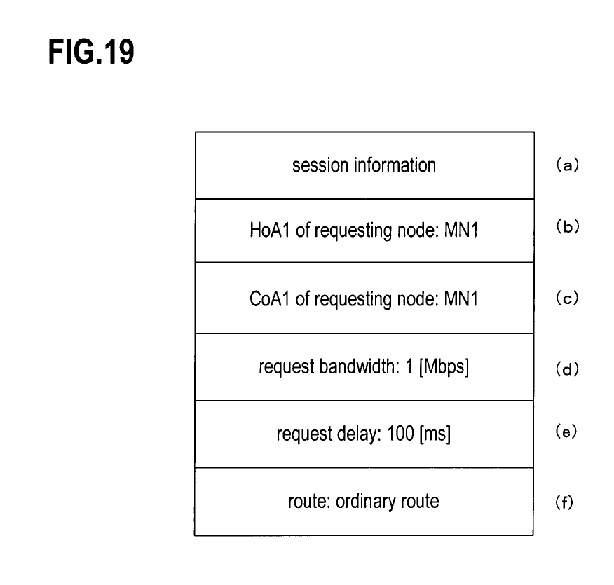

FIG. 18 shows another example of an embodiment when the resource reservation server SV1 inquires of the mobility management server HA1 about the visiting location of the mobile node MN1. At the time of resource reservation, the mobile node MN1 describes only the home address as a requesting node address, as shown by (b) in FIG. 19, and transmits the reservation message to the resource reservation server SV1.

On receipt of the above message, the resource reservation server SV1 inquires of the mobility management server HA1 so as to know whether the requesting node is a mobile node, and also to know the visiting location of the mobile node when the requesting node is a mobile node.

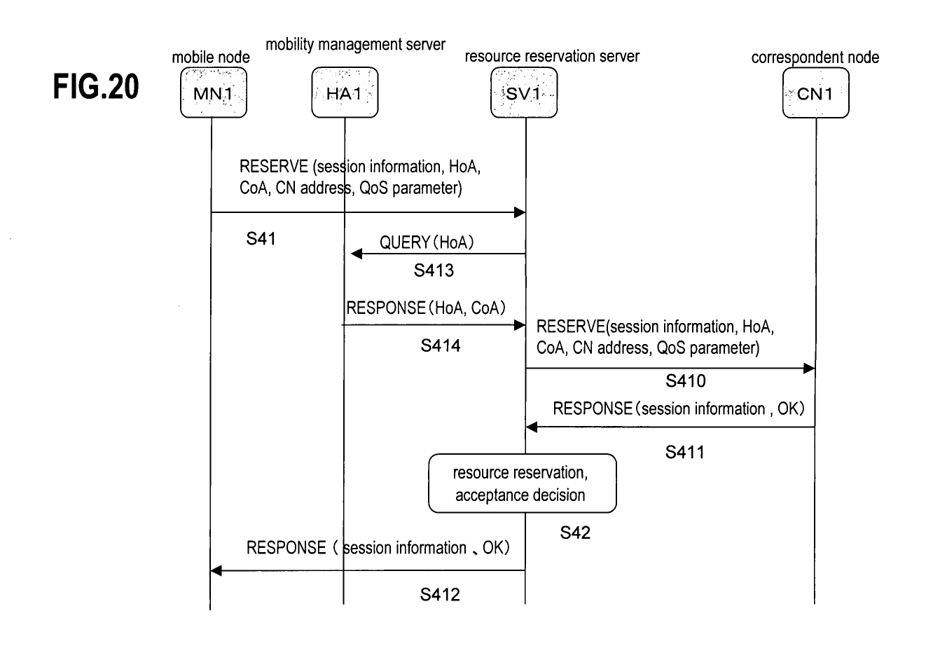

FIG. 20 shows a processing sequence of the embodiment shown in FIG. 18. In FIG. 20, as a feature when compared to the processing sequence of the first embodiment shown in FIG. 11, on receipt of the reservation message, the resource reservation server SV1 inquires of the mobility management server HA1 whether the requesting node is a mobile node MN1 (step S413) .On receipt of a response thereto, the resource reservation server SV1 confirms the home address HoA and the care-of address CoA (step S414).

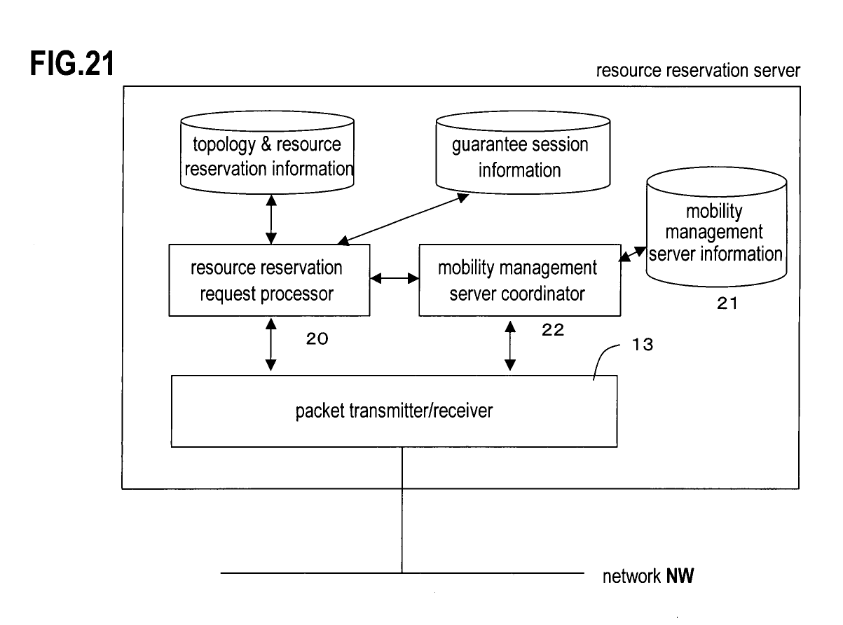

FIG. 21 shows a functional block diagram of the resource reservation server SV1 corresponding to the above embodiment.

The resource reservation server SV1 provides with a resource reservation request processor 20 for processing a reservation message; mobility management server information 21 indicating information of correspondence between the home address HoA and the mobility management server HA1; and a mobility management server coordinator 22 for inquiring of the mobility management server HA1 about the visiting location (CoA) of the mobile node MN1.

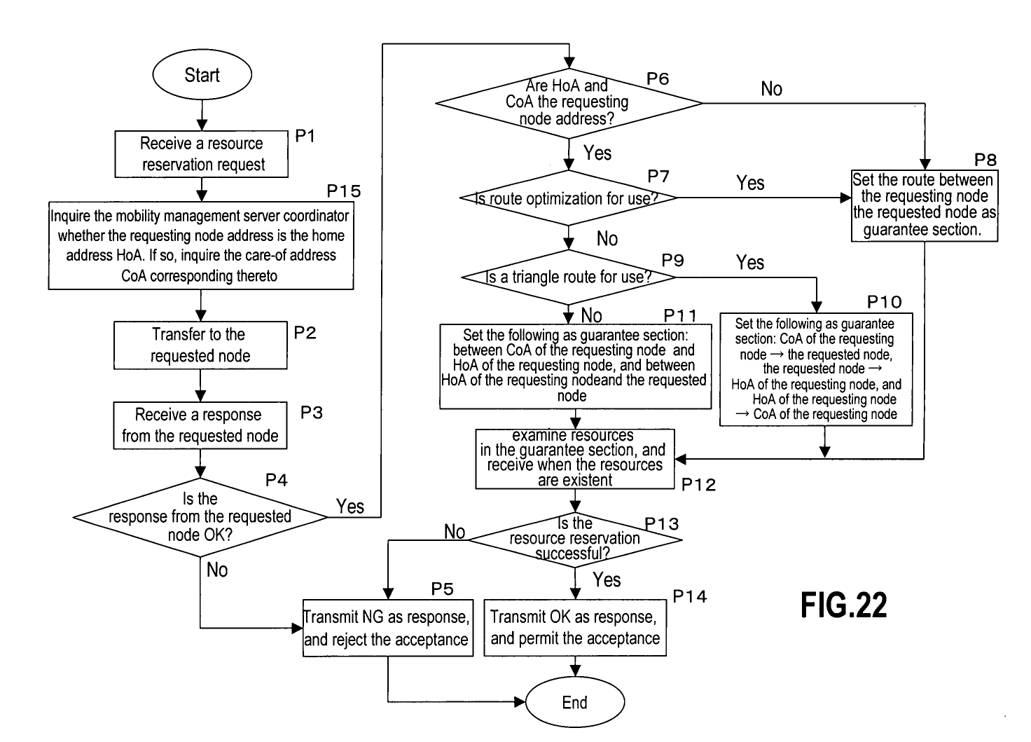

FIG. 22 shows a processing flow of resource reservation request processor 20. In FIG. 22, as a feature when comparing with the processing flow (FIG. 13) of resource reservation request processor 4 in the resource reservation server SV1 according to the first embodiment, when the resource reservation request is received (process P1), resource reservation request processor 20 searches mobility management server information 21, and inquires of the corresponding mobility management server HA1 whether the requesting address is a home address HoA. If the requesting node address is the home address HoA, the corresponding care-of address CoA is inquired (process P15) . The process thereafter is similar to that explained in FIG. 13.

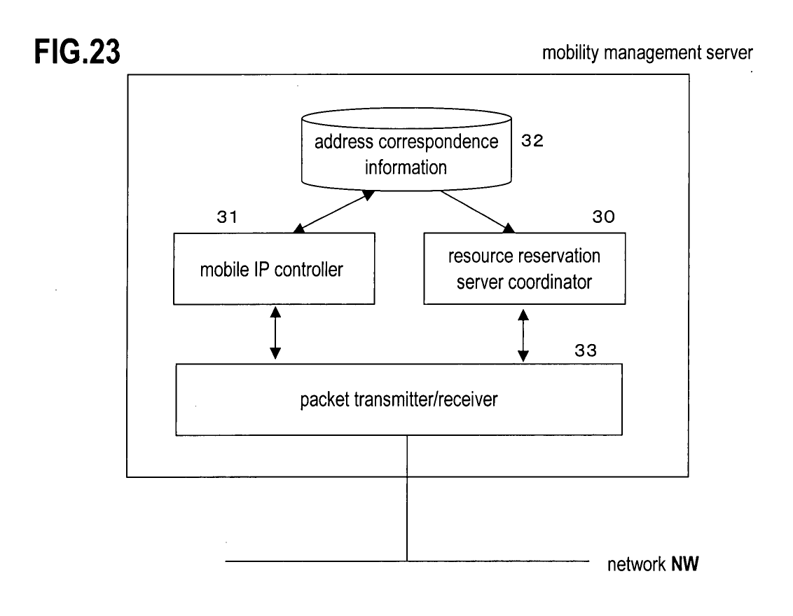

FIG. 23 shows a functional block diagram of the mobility management server HA1 in the embodiment shown in FIG. 18.

The mobility management server HA1 includes a resource reservation server coordinator 30 for responding to the inquiry from the resource reservation server SV1 in regard to the care-of address corresponding to the home address. Resource reservation server coordinator 30 refers to address correspondence information 32 generated by a mobile IP controller 31, indicating the correspondence between the home address and the care-of address, and responds with a care-of address to the inquiry. Additionally, the mobility management server performs transmission and reception of packet data to/from the network NW through a packet transmitter/receiver 33.

Thus, even when the requesting node is the mobile node MN1, the resource reservation server SV1 can know the visiting location of the mobile node MN1. Accordingly, as shown in FIG. 18, resources on routes 102, 103 through which traffic between the requesting node and the requested node passes are reserved, and thus, quality can be guaranteed.

As having been explained above, in the prior art, resource reservation cannot be performed throughout a plurality of sections for a mobile node in which Mobile IP is presupposed. Therefore, it has not been possible to provide quality guarantee end-to-end.

In contrast, according to the present invention, resource reservation can be performed for appropriate sections by recognizing a traffic route between a mobile node and a correspondent node. With this, quality guarantee for a mobile node can be provided end-to-end, which has not been effected by the prior art.

Further, it becomes possible to efficiently provide quality guarantee by combining with a technique for optimally controlling a traffic route passing through a network, in order to accept as many requests for resource reservation as possible by grasping the route between the mobile node and the correspondent node in a resource reservation server.

Accordingly, a user can receive high-quality communication service when performing mobile communication using a portable terminal such as portable telephone, PDA (personal digital assistance) and notebook PC.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A method for realizing quality guarantee in an IP network by means of a resource reservation server reserving network resources on accepting a resource reservation request from a node, the method comprising the steps of:
in a resource reservation server,
receiving the resource reservation request;
deciding whether the node initiating the resource reservation request is a mobile node; and
when the resource reservation request is initiated from the mobile node, reserving the resources on the route between the mobile node and a correspondent node passing through a mobility management server having the home address of the mobile node.

2. The quality guarantee method according to claim 1,
wherein, in the step of deciding whether the node initiating the resource reservation request is the mobile node, it is decided to be the mobile node when the request message for the resource reservation request includes the home address and a care-of address as requesting node addresses.

3. The quality guarantee method according to claim 1,
wherein, in the step of deciding whether the node initiating the resource reservation request is a mobile node, it is decided to be the mobile node when the resource reservation server receiving the resource reservation request inquires of the mobility management server about a care-of address corresponding to the requesting node address, and thereby when a care-of address is obtained.

4. The quality guarantee method according to claim 1,
wherein, when traffic from the mobile node destined to the correspondent node is transferred directly, while traffic from the correspondent node destined to the mobile node is transferred via the mobility management server, by being informed to that effect from the requesting mobile node at the time of the resource reservation request, the resource reservation server can perform resource reservation on the route between the mobile node and the correspondent node.

5. The quality guarantee method according to claim 1,
wherein, when traffic between the mobile node and the correspondent node is transferred directly through route optimization, not being transmitted through the mobility management server, by being informed to that effect from the requesting mobile node at the time of the resource reservation request, the resource reservation server can perform resource reservation on the route between the mobile node and the correspondent node.

6. The quality guarantee method according to claim 1,
wherein, on the route through which traffic between the mobile node and the correspondent node flows, when there is an encapsulation section by Mobile IP, the resource reservation server reserves a larger bandwidth than the requested bandwidth, as a resource for the section.

7. The quality guarantee method according to claim 1,
wherein, when traffic between the mobile node and the correspondent node is transmitted through the mobility management server, the resource reservation server decides whether the resource reservation can be performed, taking into account the transfer processing capacity of the mobility management server.

8. A mobile IP network system performing resource reservation on a route between communication nodes, comprising:
an IP network;
a plurality of routers disposed in the IP network;
a home network which is connected to either one of the plurality of routers, and has a mobility management server;
a mobile node having a home address in the home network;
a correspondent node which is connected to another one of the plurality of routers, and communicates with the mobile node,
the mobile node moving to an external network different from the home network, and having both a home address and a care-of address of the external network; and
a resource reservation server,
wherein the mobile node transmits a resource reservation request to the resource reservation server, and wherein the resource reservation server decides whether the received resource reservation request is initiated from the mobile node, and on deciding that the received resource reservation request is initiated from the mobile node, the resource reservation server performs resource reservation on the route between the mobile node and the correspondent node via the mobility management server having the home address of the mobile node.

9. The mobile IP network system according to claim 8,
wherein when deciding whether the node initiating the resource reservation request is a mobile node, it is decided to be the mobile node when a home address and a care-of address are included, as requesting node addresses, in the resource reservation request message.

10. The mobile IP network system according to claim 8,
wherein, when deciding whether the node initiating the resource reservation request is a mobile node, it is decided to be the mobile node when the resource reservation server receiving the resource reservation request inquires of the mobility management server about the care-of address corresponding to the requesting node address, and thereby when a care-of address is obtained.

11. The mobile IP network system according to claim 8,
wherein, when traffic from the mobile node destined to the correspondent node is transferred directly, while traffic from the correspondent node destined to the mobile node is transferred via the mobility management server, by being informed to that effect from the requesting mobile node at the time of the resource reservation request, the resource reservation server performs resource reservation on the route between the mobile node and the correspondent node.

12. The mobile IP network system according to claim 8,
wherein, when traffic between the mobile node and the correspondent node is transferred directly through route optimization, not being transmitted through the mobility management server, by being informed to that effect from the requesting mobile node at the time of the resource reservation request, the resource reservation server performs resource reservation on the route between the mobile node and the correspondent node.

13. The mobile IP network system according to claim 8,
wherein, on the route through which traffic between the mobile node and the correspondent node flows, when there is an encapsulation section by Mobile IP, the resource reservation server reserves a larger bandwidth than the requested bandwidth, as a resource for the section.

14. The mobile IP network system according to claim 8,
wherein, when traffic between the mobile node and the correspondent node is transmitted through the mobility management server, the resource reservation server decides whether the resource reservation can be performed, taking into account the transfer processing capacity of the mobility management server.
